(19) United States
(12) Patent Application Publication
(10) Pub. No.: US 2014/0129759 A1
(43) Pub. Date: May 8, 2014

(54) LOW POWER WRITE JOURNALING STORAGE SYSTEM

(71) Applicant: DELL PRODUCTS L.P., Round Rock, TX (US)

(72) Inventors: William Sauber, Georgetown, TX (US); Munif Farhan, Round Rock, TX (US)

(73) Assignee: Dell Products L.P., Round Rock, TX (US)

(21) Appl. No.: 13/670,069

(22) Filed: Nov. 6, 2012

(51) Int. Cl. G06F 12/02

(52) U.S. Cl. 711/103; 711/E12.008

(57) ABSTRACT

A low power write journaling storage system may be part of an information handling system that includes a system processor and a system memory that is coupled to the system processor. The low power write journaling storage system is coupled to the system processor and includes a non-volatile solid state memory system. A first processing element in the low power write journaling storage system is operable, while the storage system is in a storage system first mode, to journal write commands in the non-volatile solid state memory system. A second processing element in the low power write journaling storage system is operable, while the storage system is in a storage system second mode that may cause the low power write journaling storage system to consume more power than when in the storage system first mode, to execute the write commands journaled in the non-volatile solid state memory system.

### BACKGROUND

The present disclosure relates generally to information handling systems, and more particularly to low power write journaling storage system for use in an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Storage systems such as, for example, solid state drives (SSDs), implement various performance optimization and endurance improvement functions that may include, for example, physical space allocation, the mapping of logical blocks to physical storage locations, wear leveling, bad block management, garbage collection, read disturb mitigation, and a variety of other storage system functions known in the art. While these functions provide several positive features for the storage system, supporting such functions requires a full initialization of the storage system and thus consumes power that is not required for basic storage system operations, which delays when the storage system is ready for use and in many cases consumes more power than is necessary.

Accordingly, it would be desirable to provide an improved storage system.

### SUMMARY

According to one embodiment, an information handling system (IHS) includes a system processor; a system memory coupled to the system processor; and a storage system coupled to the system processor and including: a non-volatile solid state memory system; a first processing element that is operable, in a first operational mode, to journal write commands in the non-volatile solid state memory system; and a second processing element that is operable, in a second operational mode that causes the storage system to consume more power than when in the first operational mode, to execute the write commands journaled in the non-volatile solid state memory system.

### BRIEF DESCRIPTION OF THE DRAWINGS

FIG. 1 is a schematic view illustrating an embodiment of an information handling system.

FIG. 2 is a schematic view illustrated an embodiment of a low power storage system.

FIG. 3 is a schematic view illustrating an embodiment of a low power function processing element in the storage system of FIG. 2.

FIG. 4 is a flow chart illustrating an embodiment of a start-up sub-method in a method for providing a low power storage system.

FIG. 5 is a flow chart illustrating an embodiment of a full function initialization sub-method in a method for providing a low power storage system.

FIG. 6 is a flow chart illustrating an embodiment of a full function operation sub-method in a method for providing a low power storage system.

FIG. 7 is a flow chart illustrating an embodiment of a low power initialization sub-method in a method for providing a low power storage system.

FIG. 8 is a flow chart illustrating an embodiment of a low power operation sub-method in a method for providing a low power storage system.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a display device or monitor, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

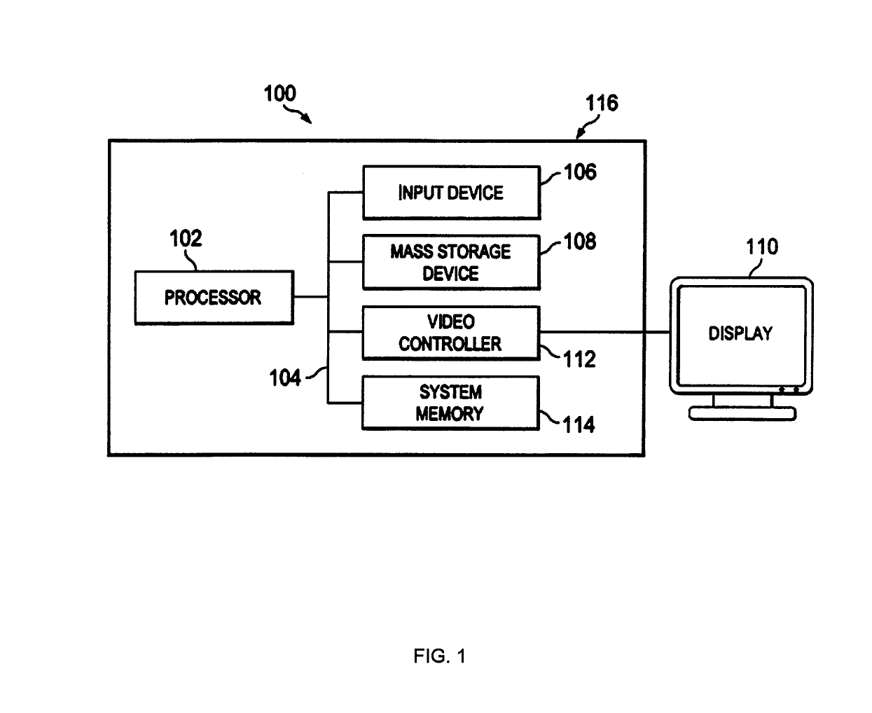

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

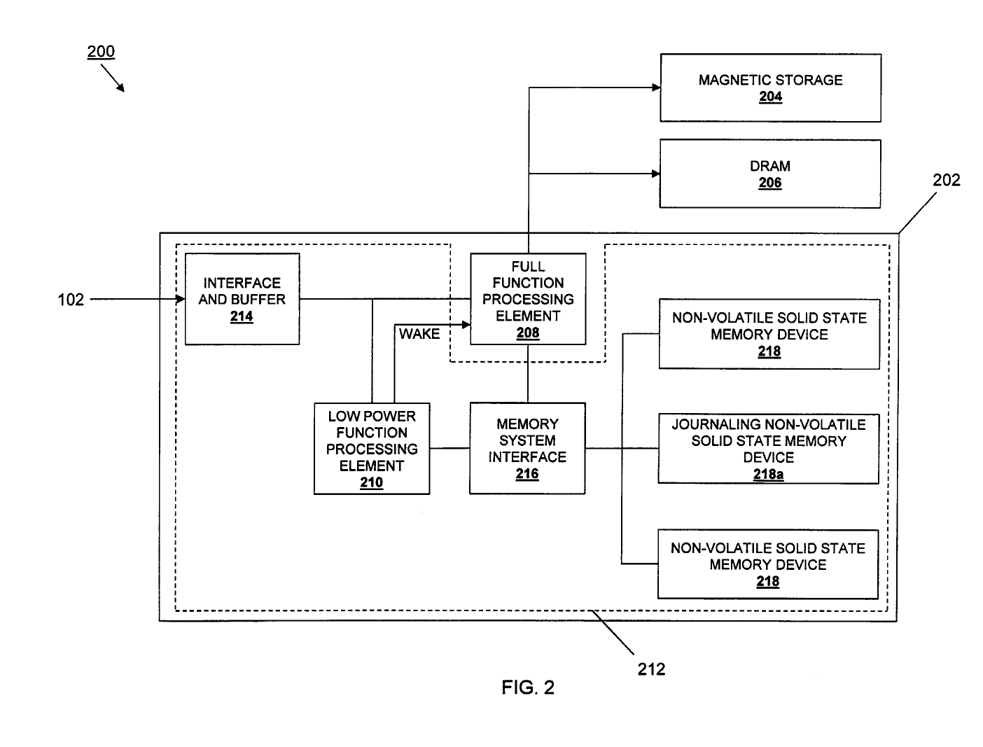

Referring now to FIG. 2, an embodiment of a storage system 200 is illustrated that may be included in the IHS 100 of FIG. 1. The storage system 200 of the present disclosure includes a multi-mode controller architecture that provides a storage system second mode (also referred to herein as a “full power mode” in some embodiments) in which the storage system 200 may perform conventional storage system functions including reads, writes, physical space allocation, the mapping of logical blocks to physical storage locations, wear leveling, bad block management, garbage collection, read disturb mitigation, and/or a variety of other storage system functions known in the art, while also providing a storage system first mode (also referred to herein as a “low power mode” in some embodiments or a “quick start” mode in some embodiments) in which the storage system 200 may perform limited functions that allow the majority of the storage system 200 to be powered down or occur while the majority of the storage system 200 is powering up. Thus, in some embodiments, upon system power up the storage system 200 may be operable to first enter the first mode prior to transitioning to the second mode in order to provide a user of the storage system 200 with a faster perceived storage system wake time. In many of the examples below, the first mode will be referred to as a “low power” mode, but it should be understood that the first/“low power” mode may be provided to enable the “quick start” mode, as discussed in some embodiments below.

As discussed below, some of the elements of the storage system 200 illustrated in FIG. 2 may be physical elements and/or functional elements in different embodiments. Furthermore, some elements of the storage system 200 in FIG. 2 may be removed from the storage system 200 while other elements may be added or modified from the configuration illustrated. For example, the storage system 200 may include a hybrid storage device that integrates both a magnetic storage device and a solid state storage device. In another example, the storage system 200 may include a separate magnetic storage device that is coupled to a separate solid state storage device. In yet another example, the storage system 200 may only utilize a solid state storage device or solid state storage devices.

The storage system 200 of the illustrated embodiment includes a storage and control device 202 that may be coupled to a magnetic storage 204 (e.g., one or more hard disk drives or other magnetic storage devices known in the art) and a dynamic random access memory (DRAM) 206. However, the storage and control device 202 may be coupled to or include a variety of other storage devices known in the art (e.g., the storage system 200 may only utilize the solid state storage devices discussed below). Thus, the magnetic storage 204 and a dynamic random access memory (DRAM) 206 of the illustrated embodiment are optional and may be removed without departing from the scope of the present disclosure. In one embodiment, the storage and control device 202 may be a single, integrated semiconductor device, while in other embodiments, the storage and control device 202 may be a plurality of connected devices. The storage and control device 202 may include one or more controllers for performing the functions of the storage system 200 discussed below. In the illustrated embodiment, the storage and control device 202 includes a full function processing element 208 and a low power function processing element 210 that act as the one or more controllers for performing the functions of the storage system 200 discussed below. However, a full function controller element and a low power function controller element utilizing other control systems may replace the full function processing element 208 and the low power function processing element 210 to perform the full function mode operations and the low power mode operations of the storage system 200 discussed below.

In an embodiment, the full function processing element 208 and the low power function processing element 210 may be provided as separate processors in the storage and control device 202. In another embodiment, the full function processing element 208 and the low power function processing element 210 may be provided by the same processor. For example, the same processor may be operated in different modes (e.g., a fully initialized mode and a partially initialized mode) to provide the full function processing element 208 and the low power function processing element 210. In yet another embodiment, the full function processing element 208 and the low power function processing element 210 may be provided by different cores in one or more processors. In yet another embodiment, the full function processing element 208 and the low power function processing element 210 may be provided by the same core in a processor. For example, the same core in a processor may be operated in different modes (e.g., a fully initialized mode and a partially initialized mode) to provide the full function processing element 208 and the low power function processing element 210. In an embodiment, the full function processing element 208 and the low power function processing element 210 may be provided by an IHS system processor (e.g., the processor 202 discussed above with reference to FIG. 1) or may be separate from the IHS system processor. While a number of examples have been provided, a variety of mechanisms may be used to provide the full function processing element 208 and the low power function processing element 210 while remaining within the scope of the present disclosure.

In an embodiment, the full function processing element 208 may be operable to perform a variety of full function operations such as, for example, reads, writes, physical space allocation, mapping of logical blocks to physical locations, wear leveling, bad block management, garbage collection, read disturb mitigation, and general command processing, along with functions involving the magnetic storage 204 and the DRAM 206 when those devices are present in the storage system 200. In one example, the full function processing element 208 may include a programmable processor core such as an Advanced Reduced Instruction Set Computer (RISC) Machine (ARM). In an embodiment, the low power function processing element 210 is operable to perform read operations, store write commands for later execution, and execute simple commands such as read status commands.

The storage and control device 202 includes a low power function section 212, indicated by the dashed line in FIG. 2, which includes components of the storage and control device 202 that provide for the low power mode operation of the storage system 200. In an embodiment, the low power function section 212 performs simple functions that may be implemented in state machines, a relatively slower and lower power processor (e.g., relative to a processor that provides the full function processing element 208), a single core of a multi-core processor, and/or using a variety of other implementations that will fall within the scope of the present disclosure. The full function processing element 208 is not included in the low power function section 212, but is coupled to a number of the components in the low power function section 212, detailed below, and, in some embodiments, to the magnetic storage device 204 and the DRAM 206. The low power function section 212 includes the low power function processing element 210 coupled to a number of other low power function components.

For example, the low power function processing element 210 may be coupled to an interface and buffer 214 that may include, for example, a Serial Advanced Technology Attachment interface, a Peripheral Component Interface express (PCIe) interface, and/or a variety of other interfaces known in the art. As is known in the art, the interface and buffer 214 may be operable to receive and hold commands sent by a another system components (e.g., the processor 102 in the illustrated embodiment.) The low power function processing element 210 and the interface and buffer 214 may each be coupled to the full function processing element 208, and the low power function processing element 210 may be operable to send a wake signal to the full function processing element 208 to enable power to the full function processing element 208 such that it may begin initialization followed by full function execution, as discussed in further detail below. The low power function processing element 210 may also be coupled to a memory system interface 216 that may include, for example, a non-volatile memory interface such as a flash memory interface or other non-volatile memory interface known in the art. The memory system interface 216 may also be coupled to a non-volatile memory system such as a non-volatile solid state memory system or other non-volatile memory system known in the art. For example, in the illustrated embodiment, the non-volatile memory system includes a plurality of non-volatile solid state memory devices 218 that include, for example, flash memory devices or other non-volatile semiconductor memory known in the art. The plurality of non-volatile solid state memory devices 218 include one or more journaling non-volatile solid state memory devices 218a, discussed in further detail below. In an embodiment, the journaling non-volatile solid state memory devices 218a may be a non-volatile solid state memory devices 218 that includes a journal that one of skill in the art will recognize may occupy a relatively small portion of that non-volatile solid state memory devices 218. The memory system interface 216 may also be coupled to the full function processing element 208.

As discussed above, the storage system 200 may include a variety of storage technologies known in the art. For example, the storage system 200 may include or provide a hybrid storage device that integrates the magnetic storage 204 and the non-volatile solid state memory system (i.e., the non-volatile solid state memory devices 218, 218a.) In another example, the storage system 200 may include a plurality of storage devices such as the magnetic storage 204 (e.g., a separate hard disk drive) and the non-volatile solid state memory system (i.e., the non-volatile solid state memory devices 218, 218a) coupled together as separate devices. In another example, the storage system 200 may include a solid state memory device such as the non-volatile solid state memory system (i.e., the non-volatile solid state memory devices 218, 218a), with the magnetic storage 204 omitted.

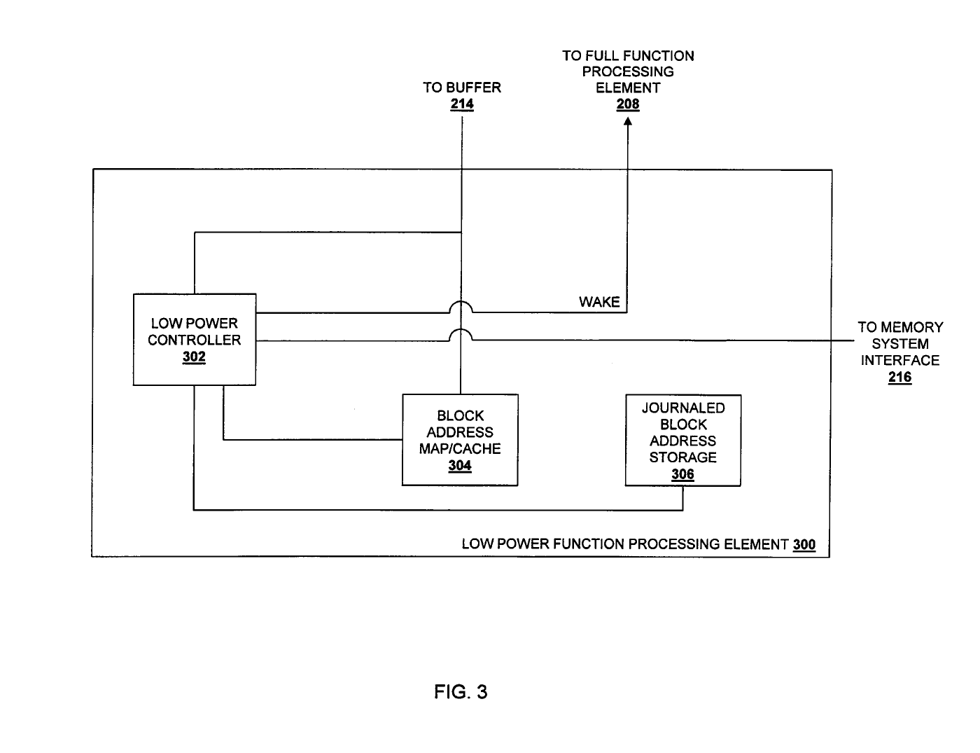

Referring now to FIG. 3, an embodiment of a low power function processing element 300 is illustrated. In an embodiment, the low power function processing element 300 may be the low power function processing element 210, discussed above with reference to FIG. 2, and thus may be coupled to the full function processing element 208, the buffer 214, and the non-volatile solid state memory system through the memory system interface 216, as illustrated. The low power function processing element 300 includes a low power controller 302 that is operable to control the functions of the low power function processing element 300, discussed below, and that is coupled to the full function processing element 208, the buffer 214, the memory system interface 216, a block address map/cache 304, and a journaled block address storage 306. In the illustrated embodiment, the block address map/cache 304 is also coupled to the buffer 214.

In some embodiments, the block address map/cache 304 may be the address of a logical to physical block address map without a cache, while in other embodiments, the block address map/cache 304 may cache a portion of the logical to physical address map. Embodiments using the relatively “simple” logical to physical block address map without a cache may reduce power consumption by the device, while embodiments using the logical to physical block address map with a cache may improve performance.

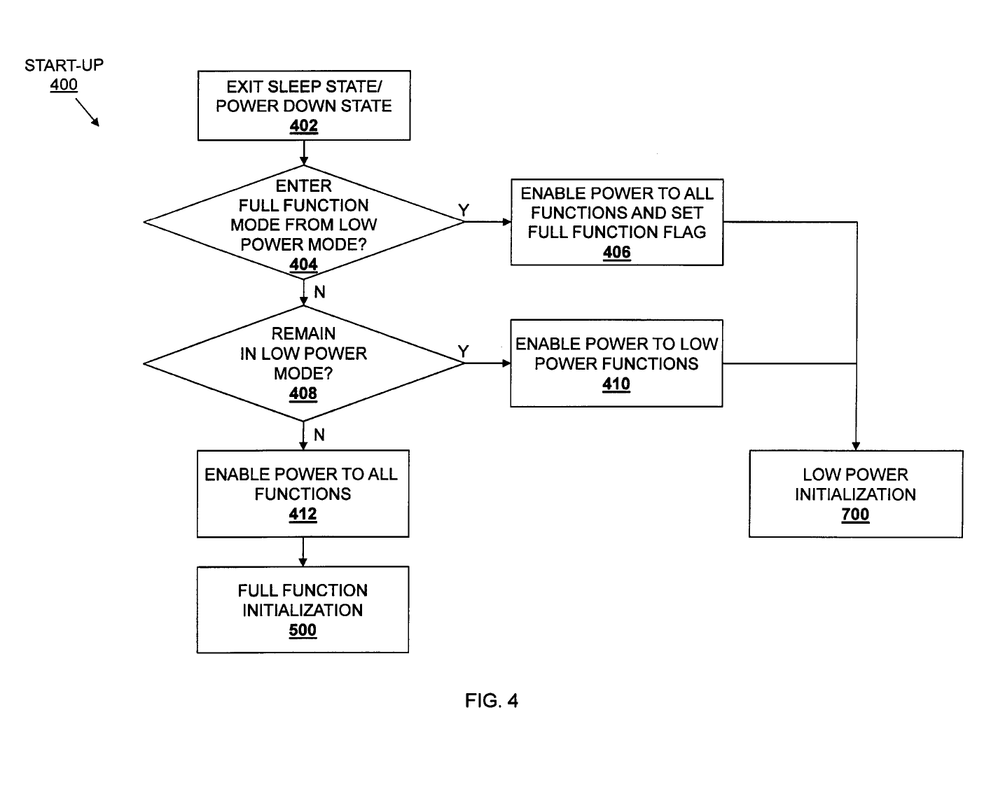

Referring now to FIGS. 4, 5, 6, 7, and 8, a method for providing a storage system is illustrated and described with reference to the storage system illustrated in FIGS. 2 and 3. The illustrated embodiment of the method is broken up into several sub-methods for clarity of description, but it should be understood that the method of the present disclosure may have sub-method blocks moved around, modified, removed, and/or otherwise performed in a different order than presented herein while still remaining within the scope of the present disclosure. In an embodiment, the method for providing a low power storage system may begin with start-up sub-method 400, illustrated in FIG. 4. The start-up sub-method 400 may be performed when IHS including the storage system 200 is initially powered down, in a deep power down state, or in a sleep mode, and is then powered up using quick-start mode, powered up into a low power mode, or powered up into a full function mode. The start-up sub-method 400 may also be performed when the IHS including the storage system 200 is already powered up (e.g., in a low power mode) and controlling the operation of the storage system in a manner that is transparent to an IHS user and controlled at least in part by power management policies implemented in the Basic Input/Output System (BIOS), drivers, and/or operating system. However, the method for providing a low power storage system may begin in a variety of other manners while remaining within the scope of the present disclosure.

The start-up sub-method 400 begins at block 402 where the system is powered on, exits a deep power down state, exits a sleep state, and/or otherwise is instructed to begin operations from a substantially non-operational state. In an embodiment, the storage system 200 is included in an IHS (e.g., the IHS 100) that is powered down, in a deep power down state, or in a sleep mode, and at block 402, the IHS may be powered up or woken from the sleep state by, for example, a user pressing a power button or otherwise activating the IHS using methods known in the art. The start-up sub-method 400 then proceed to decision block 404 where it is determined whether the storage system should enter a full function mode from a low power mode. In an embodiment, decision block 404 is performed by the IHS using power management policies implemented in the BIOS, drivers, and/or operating system. In an embodiment, the storage system 200 may be configured to perform a “quick start” in which the storage system enters the full function mode from the low power mode, or may be instructed (e.g., by the BIOS, drivers, and/or operating system according to parameters set and modified by software entities to implement a power management policy that may, in some cases, be selected by a user of the IHS) to perform the “quick start” by entering the full function mode from the low power mode. In such a situation, at decision block 404, it will be determined that the storage system 200 is performing the “quick start” by entering the full function mode from the low power mode, and the start-up sub-method 400 will proceed to block 406 where power is enabled to all functions and a full function flag is set in the storage system 200. In an embodiment, at block 406, power is enabled to the full function processing element 208 along with the components of the low power function section 212 on the storage and control device 202. In an embodiment, the full function flag may be set by the processor 210 to indicate that the method 400 should initialize and then enter the full function mode without further instruction or guidance from the BIOS, drivers, and/or operating system, but while processing certain commands before being completely initialized, as described below. The start-up sub-method 400 then proceeds to the low power initialization sub-method 700, discussed in further detail below.

If, at decision block 404, it is determined that the storage system is not entering the full function mode from the low power mode, the start-up sub-method 400 then proceeds to decision block 408 where it is determined whether the storage system will remain in a low power mode. In an embodiment, the storage system 200 may be configured to remain in the low power mode or may be instructed to remain in the low power mode (e.g., by the BIOS, drivers, and/or operating system according to parameters set and modified by software entities to implement a power management policy). In such a situation, at decision block 408, it will be determined that the storage system 200 is remaining in a low power mode and the start-up sub-method 400 will proceed to block 410 where power is enabled to low power functions. In an embodiment, at block 410, power is enabled to the components of the low power function section 212 on the storage and control device 202. In some embodiments, at block 410, power may not be provided to the full function processing element 208, and some of the non-volatile solid state memory devices 218 in the non-volatile solid state memory system may not be provided power (e.g., when the storage system 200 is implemented with a solid state storage system as its primary storage system). The start-up sub-method 400 then proceeds to the low power initialization sub-method 700, discussed in further detail below.

If, at decision block 408, it is determined that the storage system is not remaining in a low power mode, the start-up sub-method 400 then proceeds to block 412 where power is enabled to all functions. In an embodiment, the storage system 200 may be configured to enter a full function mode or may be instructed to enter the full function mode (e.g., by the BIOS, drivers, and/or operating system according to parameters set and modified by software entities to implement a power management policy), and the start-up sub-method 400 will proceed to block 412 where power is enabled to the full function processing element 208 along with the components of the low power function section 212 on the storage and control device 202 (and in some embodiment, along with the magnetic storage device 204 and/or the DRAM 206, if present). The start-up sub-method 400 then proceeds to the full function initialization sub-method 500, discussed in further detail below.

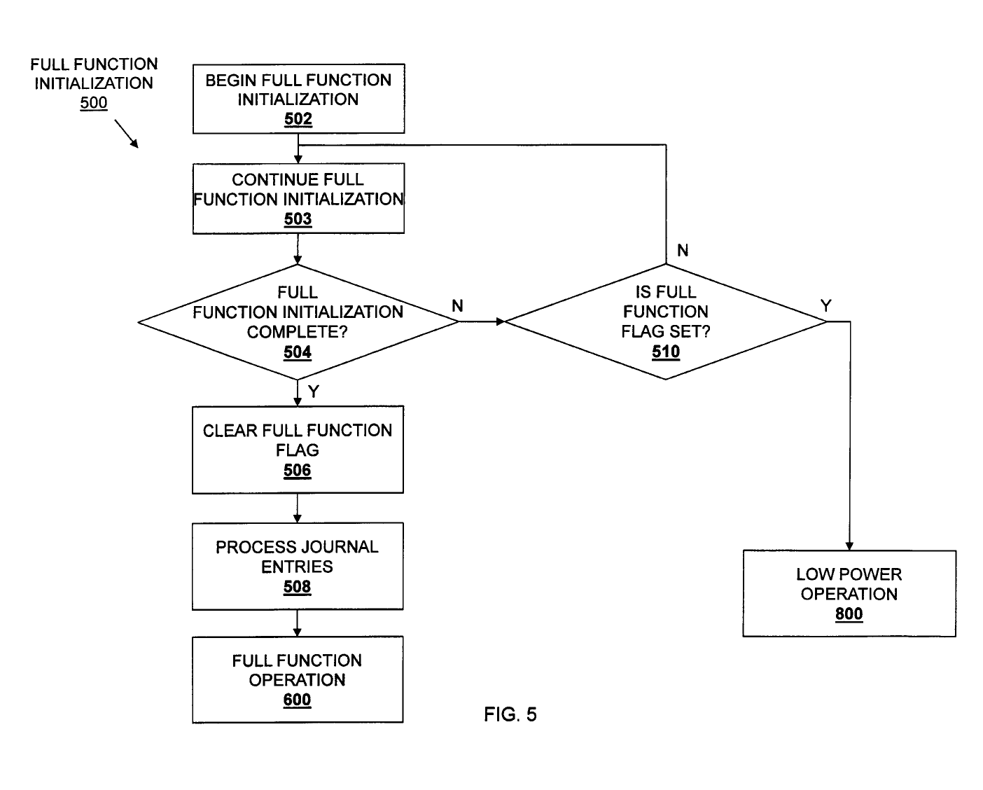

Referring now to FIG. 5, an embodiment of a full function initialization sub-method 500 that is part of the method for providing a storage system is illustrated. The full function initialization sub-method 500 may be performed following block 412 of the start-up sub-method 400 when the storage system 200 is configured or instructed to enter the full function mode, discussed above, or following block 834 of the low power operation sub-method 800 when the storage system 200 is performing a “quick start” and entering the full function mode from the low power mode, discussed above and in further detail below.

The full function initialization sub-method 500 begins at blocks 502 and 503 where full-function initialization begins and continues. In an embodiment, at blocks 502 and 503, initialization of the full function processing element 208 may be performed that includes, for example, initialization of hardware (e.g., the magnetic storage device 204, the DRAM 206, and/or the full function processing element 208), loading and initialization of additional software functions such as, for example, wear leveling, bad block management, etc. In an embodiment, blocks 502 and 503 may require approximately 100 to 150 milliseconds (not including spinning up magnetic storage devices.) The full function initialization sub-method 500 then proceeds to decision block 504 where it is determined whether the full function initialization is complete. In an embodiment, full function initialization may be completed when the software initialization functions discussed above have been completed (e.g., as executed and/or monitored by the processor 208). If, at decision block 504, it is determined that full function initialization is complete, the full function initialization sub-method 500 then proceeds to block 506 where the full function flag is cleared (in some embodiments, the full function flag has not been set before block 506, but one of skill in the art would recognize that logic simplification allows for the “clearing” of an unset flag rather than testing for whether the flag has been set.) The full function initialization sub-method 500 then proceeds to block 508 where journal entries are processed. As discussed in further detail below, while performing the low power operation sub-method 800, write commands received by the low power function processing element 210 may be journaled in the journaling non-volatile solid state memory device 218a in the non-volatile solid state memory system (e.g., via the memory system interface 216.) At block 508 of the full function initialization sub-method 500, the full function processing element 208 may process write commands journaled in the journaling non-volatile solid state memory device 218a to write data to the non-volatile solid state memory devices 218, the magnetic storage device 204, and/or other full power storage devices used in the storage system 200 The full function initialization sub-method 500 then proceeds to the full function operation sub-method 600, discussed in further detail below.

If, at decision block 504, it is determined that full function initialization is not complete, the full function operation sub-method 500 then proceeds to decision block 510 where it is determined whether the full function flag is set. If, at decision block 510, it is determined that the full function flag is not set, the full function initialization sub-method 500 returns to block 503 to continue full function initialization. Thus, if the full function flag is not set, the full function initialization sub-method 500 will continue full function initialization until full function initialization is complete, followed by the performance of blocks 506 and 508 before performing the full function operation sub-method 600, described below (note that, in some embodiments, there may be no journal entries to process if the low power mode was not entered.) If, at decision blocks 504 and 510, it is determined that full function initialization is not complete and the full function flag is set, the full function initialization sub-method 500 proceeds to the low power operation sub-method 800 such that low power mode operations may be performed while full function initialization is completed, discussed in further detail below.

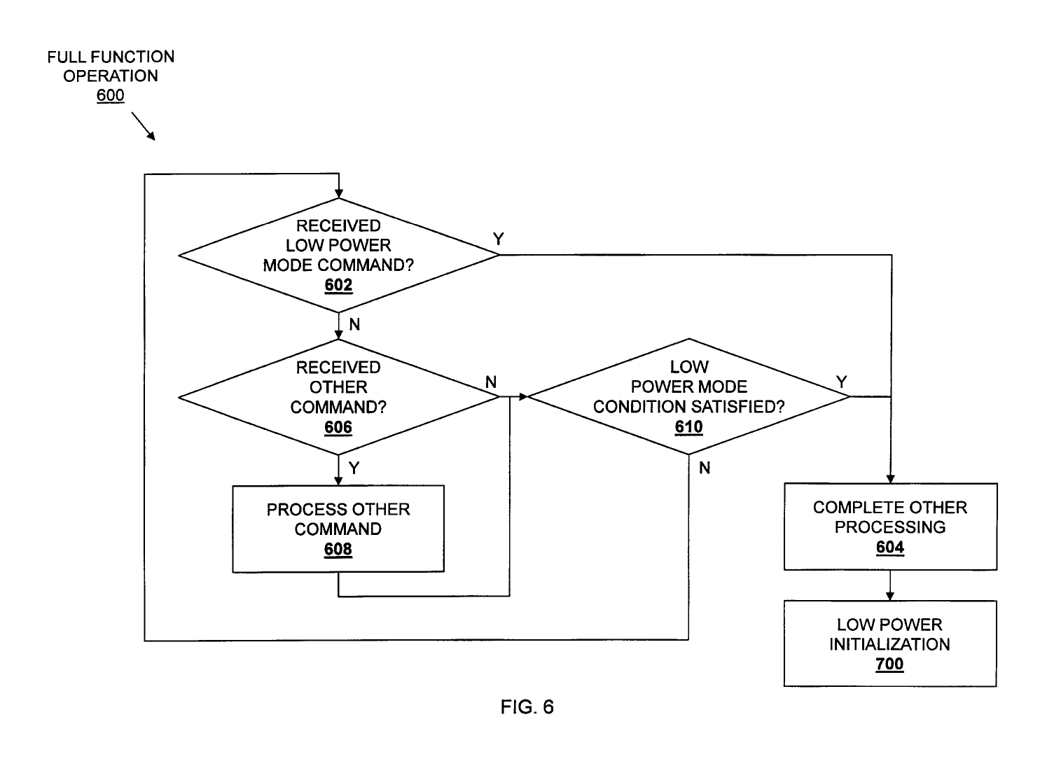

Referring now to FIG. 6, an embodiment of a full function operation sub-method 600 that is part of the method for providing a storage system is illustrated. The full function operation sub-method 600 may be performed following block 508 of the full function initialization sub-method 500 after the storage system 200 has completed full function initialization, discussed above. The full function operation sub-method 600 begins at decision block 602 where it is determined whether a low power mode command is received. In an embodiment, upon beginning the full function operation sub-method 600, the storage system 200 is in full function operation in which the full function processing element 208 is operable to perform the full function operations of the storage system 200 including reads, writes, physical space allocation, wear leveling, bad block management, garbage collection, read disturb mitigation, and/or a variety of other storage system full function operations known in the art. At decision block 602, the full function processing element 208 may receive a command to enter a low power mode (i.e., a ‘low power mode command’). Low power mode commands may include operating system commands based on application operation, driver commands based on processor state exits, drive state changes based on utilization decreases, and/or commands received in a variety of other scenarios known in the art for transitioning from a full function mode to a low power mode. If, at decision block 602, it is determined that a low power mode command is received, the full function operation sub-method 600 proceeds to block 604 where other processing is completed. In an embodiment, prior to entering a low power mode subsequent to receiving a low power mode command, the full function processing element 208 may complete other processing such as, for example, completing wear leveling, garbage collection, read disturb mitigation, moving logical items among physical locations, and/or other processing mentioned above and/or known in the art. The full function operation sub-method 600 then proceeds to the low power initialization sub-method 700, discussed in further detail below.

If, at decision block 602, it is determined that a low power mode command has not been received, the full function operation sub-method 600 proceeds to decision block 606 where it is determined whether other commands have been received. In an embodiment, other commands may be a variety of other full function commands known in the art that may be received by the full function processing element 208 such as, for example, read commands, write commands, status commands, and/or physical space allocation commands, along with operations triggered by conditions in the storage system such as the mapping of logical blocks to physical storage locations, wear leveling, bad block management, garbage collection, read disturb mitigation, and a variety of other storage system full function operations known in the art. If, at decision block 606, it is determined that other commands have been received, the full function operation sub-method 600 proceeds to block 608 where those other commands are processed. In an embodiment, the full function processing element 208 is operable to process any other command determined to have been received at decision block 606. If, at decision block 606, it is determined that no other commands have been received, or following block 608, the full function operation sub-method 600 proceeds to decision block 610 where it is determined whether a low power mode condition has been satisfied. In an embodiment, while the storage system 200 is in full function operation, one or more conditions (i.e., ‘low power mode conditions’) may occur that will cause the storage system 200 to transition to the low power mode. For example, the storage system 200 may enter a low power mode based on a low command rate, and/or in due to a variety of other low power entry conditions. If, at decision block 610, it is determined that no low power mode condition has been detected, the full function operation sub-method 600 returns to decision block 602. If, at decision block 610, it is determined that a low power mode condition has been detected, the full function operation sub-method 600 proceeds to block 604 to complete other processing, such as garbage collection and other previously mentioned complex operations that may be in progress, such that the low power initialization sub-method 700 may be performed, as discussed above.

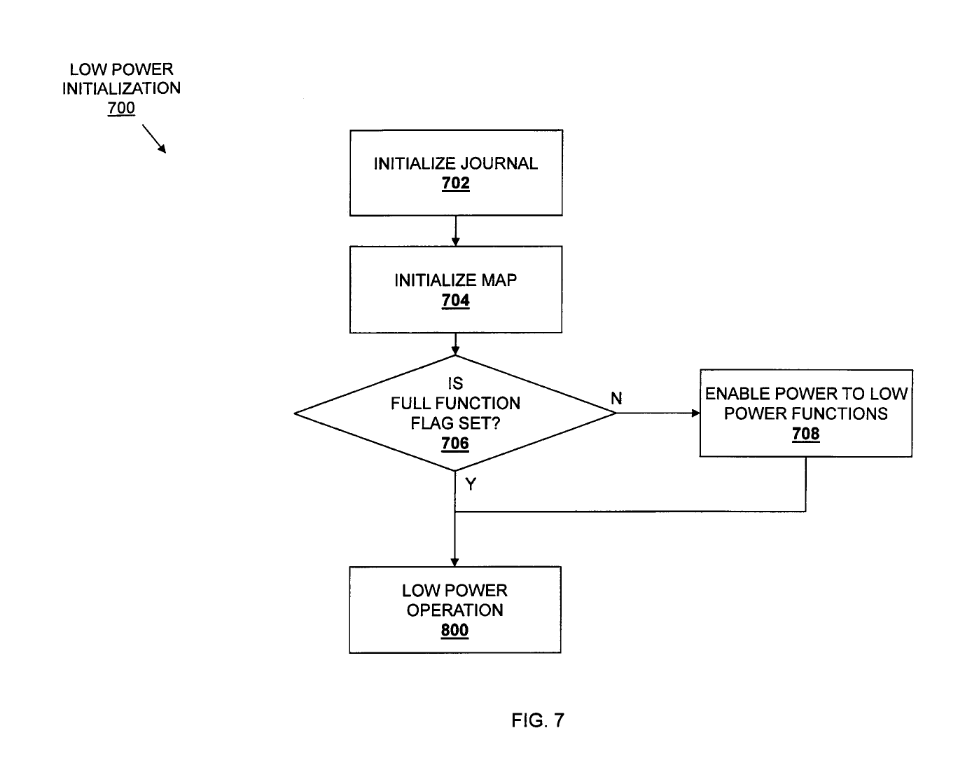

Referring now to FIG. 7, an embodiment of a low power initialization sub-method 700 that is part of the method for providing a storage system is illustrated. The low power initialization sub-method 700 may be performed following block 406 of the start-up sub-method 400 when the storage system 200 is performing a “quick start” by entering the full function mode from the low power mode, discussed above, following block 410 of the start-up sub-method 400 when the storage system is entering the low power mode, or following block 604 of the full function operation sub-method 600 when the storage system is transitioning from the full function mode to the low power mode in response to receiving a low power mode command or detecting a low power mode condition, discussed above.

The low power initialization sub-method 700 begins at block 702 where a journal is initialized. In an embodiment, at block 702, the low power function processing element 210 initializes the journaling non-volatile solid state memory device 218a by, for example, setting a physical starting address and journal size (which, in an embodiment, may have been stored in the memory devices 218 and/or other nonvolatile memory) in the low power function processing element 210. The low power initialization sub-method 700 then proceeds to block 704 where a map is initialized. In an embodiment, at block 704, the low power function processing element 210/300 initializes the block address map/cache 304 by, for example, reading the address of the logical to physical block map which may have been stored in the memory devices 218 and/or other nonvolatile memory. The low power initialization sub-method 700 then proceeds to decision block 706 where it is determined whether the full function flag is set. If, at decision block 706 it is determined that the full function flag is not set, the low power initialization sub-method 700 proceeds to block 708 where power is enabled to low power functions. In an embodiment, at block 708, power is enabled to the components of the low power function section 212 on the storage and control device 202 (and power may be disabled, not supplied, or supplied in a very limited amount to the full function components of the storage system.) If, at decision block 706, it is determined that the full function flag is set, or following block 708, the low power initialization sub-method 700 proceeds to the low power operation sub-method 800, discussed in further detail below.

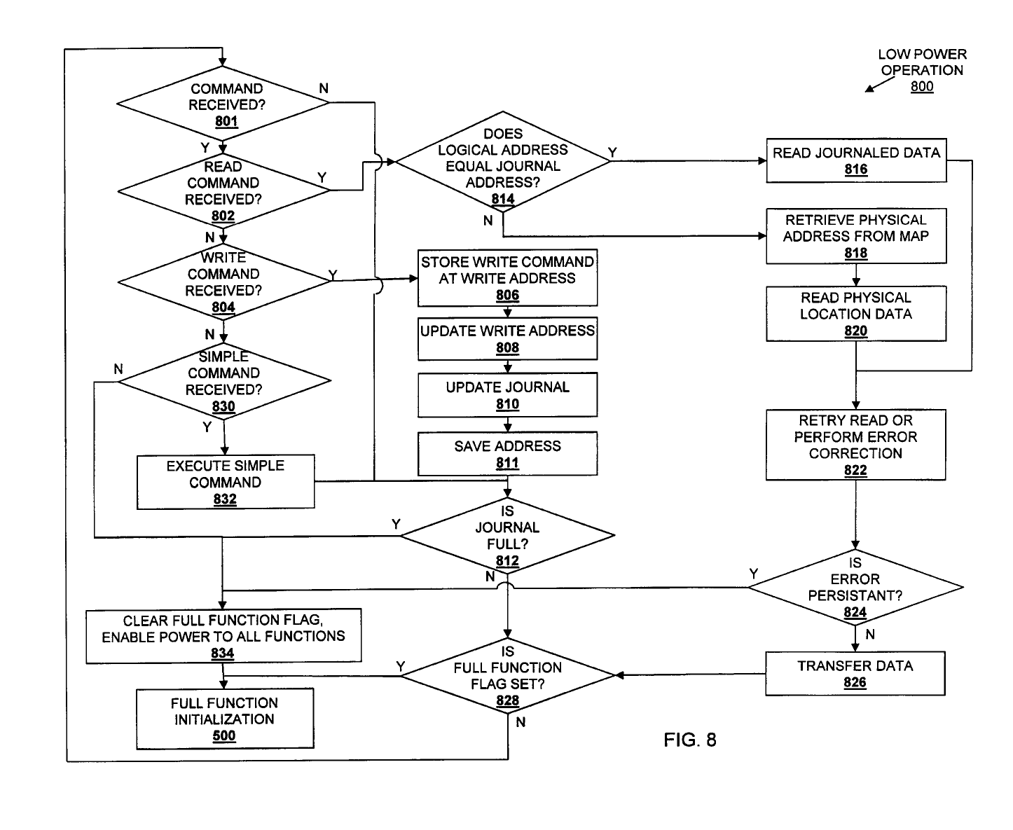

Referring now to FIG. 8, an embodiment of a low power operation sub-method 800 that is part of the method for providing a storage system is illustrated. The low power operation sub-method 800 may be performed when the storage system is performing a “quick start” and entering a full function mode from a low power mode, e.g., in response to determining that full function initialization is not complete and the full function flag is set at decision blocks 504 and 510 of the full function initialization sub-method 500, or following the low power initialization sub-method 700, discussed above. The low power operation sub-method 800 begins at decision block 801 where it is determined whether a command has been received. In an embodiment, at decision block 801, the low power function processing element 210 may determine whether a command has been received at the interface and buffer 214. If, at decision block 801, it is determined that no command has been received, the method 800 proceeds to decision block 812, discussed in further detail below. If, at decision block 801, it is determined that a command has been received, the method 800 proceeds to decision block 802 where it is determined whether a read command was received. In an embodiment, the low power function processing element 210 may determine whether a read command has been received at the interface and buffer 214. If, at decision block 802, it is determined that a read command has not been received, the low power operation sub-method 800 proceeds to decision block 804 where it is determined whether a write command was received. In an embodiment, the low power function processing element 210 may determine whether a write command has been received at the interface and buffer 214.

If, at decision block 804, it is determined that a write command has been received, the low power operation sub-method 800 proceeds to blocks 806, 808, and 810 where the write command is journaled. In an embodiment, in response to receiving a write command, the low power function processing element 210 journals that write command in blocks 806, 808, and 810. In other embodiments, a command that requires most of the storage system 200 to be initialized and powered may be stored similarly to the write commands in blocks 806, 808, and 810. For example, TRIM commands, configuration commands, and/or a variety of other commands known in the art may be journals similarly as discussed below for write commands.

In one example, at block 806, the low power controller 302 in the low power function processing element 210/300 may store the write command at a journal write address in the journaling non-volatile solid state memory device 218a via the memory interface 216. At block 808, the low power controller 302 in the low power function processing element 210/300 may update the journal write address to the next available location in journaling non-volatile solid state memory device 218a. At block 810, the low power controller 302 in the low power function processing element 210/300 may update the journal by decreasing the journal size initialized in block 702. At block 811, the low power controller 302 may then save the logical address for the write command stored at block 806 in the journaled block address storage 306. While a specific example has been provided for journaling write commands, one of skill in the art will recognize that other commands may be journaled with some modifications to blocks 806, 808, 810, and 811 without departing from the scope of the present disclosure.

The low power operation sub-method 800 then proceeds to decision block 812 where it is determined whether the journal is full. As discussed above, decision block 812 may also be performed following a determination at decision block 801 that no command has been received. In an embodiment, discussed in further detail below, when the journaling non-volatile solid state memory device 218a is full or within a predetermined amount of being full, the storage system may transition from the low power mode (e.g, low power operation sub-method 800) to the full function mode (e.g., full function operation sub-method 600) to execute the write commands stored in the journaling non-volatile solid state memory device 218a (e.g., see block 508 where journal entries are processed.) In other embodiments, other functions that require most of the storage system 200 to be initialized and powered may be delayed until the journaling non-volatile solid state memory device 218a is full or within a predetermined amount of being full. If, at decision block 812, it is determined that the journal is full, the sub-method 800 proceeds to block 834, discussed in further detail below.

If, at decision block 802, it is determined that a read command has been received by the storage system 200, the low power operation sub-method 800 proceeds to decision block 814 where it is determined whether a logical address of the read command equals a journaled write logical address. In an embodiment, at decision block 814, the low power function processing element 210/300 retrieves a logical address included in the read command received at decision block 802 and the low power controller 302 may determine whether that logical address corresponds to any addresses stored in the journaled block address storage 306 that correspond to previous write commands journaled in the journaling non-volatile solid state memory device 218a. If the logical address in the read command corresponds to an address in the journaled block address storage 306 at decision block 810, the low power operation sub-method 800 proceeds to block 816 where journaled data is read. In an embodiment, at block 816, the low power function processing element 210 uses the location of the logical address in 306 which matches the logical address of the read command to locate and read data from the journaling non-volatile solid state memory device 218a.

If, at decision block 818, the logical address in the read command does not corresponds to a address in the journaled block address storage 306, the low power operation sub-method 800 may proceed to block 818 where a physical address is retrieved from a map. In an embodiment, the low power function processing element 210/300 may retrieve a physical address for the read command received at decision block 814 by, for example, using the low power controller 302 to retrieve a physical address from the block address map/cache 304. For example, the physical address may be retrieved that was added to the map/cache 204 during a prior low power mode read operation. In some embodiments, (e.g., one which does not include a cache, but rather simply the address of the logical to physical block address map in the non-volatile solid state memory 218), the low power controller 302 may retrieve the appropriate logical to physical entry from non-volatile solid state memory 218 to acquire the correct physical address. The low power operation sub-method 800 then proceeds to block 820 where data is read from a physical location. In an embodiment, the low power function processing element 210 may use the physical address retrieved in block 818 to read a physical location on a memory device that stores data corresponding to the read command received at decision block 802. For example, data may be retrieved that was written to this physical address during a variety of high level functions such as, for example, the writing of new data, wear leveling, bad block management, and/or a variety of other high level functions known in the art In one example, the data corresponding to the read command is stored on a solid state storage system (e.g., the non-volatile solid state memory devices 218), and the low power function processing element 210 may be operable to power up any portion of the non-volatile solid state memory devices 218 (if necessary) to read that data.

Following blocks 816 or 820, the low power operation sub-method 800 proceeds to block 822 where the read is retried or error correction is performed. In an embodiment, the low power function processing element 210 may retry the read or perform error correction operations on the data read in blocks 816 or 820. In an embodiment, error correction operations may include a variety of operations known in the art. In addition, the memory devices 218 and 218a may include error correction. Furthermore, error correction may be conducted on errors that occur when reading entries into the logical to physical address map that is stored in the memory devices 218. The low power operation sub-method 800 then proceeds to decision block 824 where it is determined whether an error is persistent. In an embodiment, the low power function processing element 210 is operable determine whether an error associated with data read in blocks 816 and/or 820 is persistent. If, at decision block 824, it is determined that an error is not persistent, the low power operation sub-method 800 proceeds to block 826 where data is transferred. In an embodiment, the low power function processing element 210 transfers data from the location specified in block 816 or 820 to a storage location such as, for example, to the buffer and back to other IHS components across the storage interfaces. If, at decision block 824, it is determined that an error is persistent, the low power operation sub-method 800 proceeds to block 834, discussed in further detail below.

If at decision block 812 it is determined that the journal is not full, or following block 826, the low power operation sub-method 800 proceeds to decision block 828 where it is determined whether the full function flag is set. In an embodiment the low power function processing element 210 may determine whether a full function flag is set in the storage system 200. If, at decision block 828, it is determined that the full function flag is not set, the low power operation sub-method 800 returns to decision block 801 to determine whether a command is received. If, at decision block 828, it is determined that the full function flag is set, the low power operation sub-method 800 proceeds to the full function initialization sub-method 500, discussed above. Thus, in the embodiment in which the storage system 200 is performing a “quick start” to enter full function mode from low power mode (and in which the full function flag will be set), the storage system will return to the full function initialization sub-method 500 and enter the full function operation sub-method 600 if full function initialization is complete, or return to the low power operation sub-method 800 if full function initialization is not complete.

If, at decision block 804, it is determined that write command has not been received, the low power operation sub-method 800 proceeds to decision block 830 where it is determined whether a simple command is received. In an embodiment, the low power function processing element 210 is operable to determine whether a simple command such as, for example, a status command, is received. For example, the low power function processing element 210 may determine whether a read status, read parameter, or other standard storage command defined by the storage interface being used is received. If, at decision block 830, it is determined that a simple command is received, the low power operation sub-method 800 proceeds to block 832 where the simple command is executed. In an embodiment, the low power function processing element 210 is operable to execute simple commands received at decision block 830. Following block 832, the method 800 proceeds to decision block 812, discussed above. If, at decision block 830, it is determined that a simple command has not been received, the low power operation sub-method 800 proceeds to block 834 where the full function flag is cleared and power is enabled to all functions (e.g., because a command has been received that cannot be executed or journaled in the lower power mode.) In an embodiment, at block 834, the full function flag is cleared and power is enabled to the full function processing element 208 along with the components of the low power function section 212 on the storage and control device 202. The low power operation sub-method 800 then proceeds to the full function initialization sub-method 500, discussed above.

Thus, a low power storage system and method has been described that provides both a second/full function mode in which the storage system executes a plurality of full function operations known in the art, along with a first/low power/quick start mode where read commands may be executed and write commands are journaled. Other complex function may be delayed in the low power operation mode until a number of writes have been journaled, which allows major portions of the storage system to be powered down and, in the case of a solid state drive, few or none of the non-volatile solid state memory devices to be powered up. The first/low power/quick start operation mode may be utilized for a “quick start” to power up to the full function operation mode in order to provide a faster perceived wake time as well. Potential power reductions in periods of low utilization and low power states such as, for example, an Intel® processor S0i3 power mode, connected standby, or audio playback may be implemented using the low power mode of the storage system and method discussed above, and the low power mode may be used with other conventional techniques including DRAM disable and individual flash storage device power down.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A storage system, comprising:
a non-volatile solid state memory system;
a first controller element that is coupled to the non-volatile solid state memory system and that is operable, with the storage system in a first operational mode, to receive write commands and journal the write commands in the non-volatile solid state memory system; and
a second controller element that is coupled to the non-volatile solid state memory system and the first controller element, wherein the second controller element is operable, with the storage system in a second operational mode, to execute the write commands journaled in the non-volatile solid state memory system.

2. The storage system of claim 1, wherein the first controller element is further operable, with the storage system in the first operational mode, to receive read commands and execute the read commands.

3. The storage system of claim 2, wherein the read commands each include a logical address and the first controller element is further operable to determine that a logical address for a read command corresponds to a journaled address for a write command journaled in the non-volatile solid state memory system and, in response, read data from the non-volatile solid state memory system.

4. The storage system of claim 1, wherein the first operational mode consumes less power than the second operational mode.

5. The storage system of claim 1, wherein the storage system is operable to switch from the first operational mode to the second operational mode in response to the number of write commands journaled in the non-volatile solid state memory system exceeding a predetermined amount.

6. The storage system of claim 1, wherein in response to detecting a power up and determining that the storage system is in the second operational mode, the storage system first enters the first operational mode before transitioning to the second storage system power mode.

7. The storage system of claim 1, wherein in response to determining that a first operational mode event has occurred while the storage system is in the second operational mode, the storage system transitions to the first operational mode.

8. An information handling system (IHS) comprising:
a system processor;
a system memory coupled to the system processor; and
a storage system coupled to the system processor and including:
a non-volatile solid state memory system;
a first processing element that is operable, in a storage system first mode, to journal write commands in the non-volatile solid state memory system; and
a second processing element that is operable, in a storage system second mode, to execute the write commands journaled in the non-volatile solid state memory system.

9. The IHS of claim 8, wherein the first processing element is further operable, in the storage system first mode, to receive read commands and execute the read commands.

10. The IHS of claim 9, wherein the read commands each include a logical address and the first processing element is further operable to determine that a logical address for a read command corresponds to a journaled address for a write command journaled in the non-volatile solid state memory system and, in response, read data from the non-volatile solid state memory system.

11. The IHS of claim 8, wherein the storage system first mode consumes less power than the storage system second mode.

12. The IHS of claim 8, wherein the storage system is operable to switch from the storage system first mode to the storage system second mode in response to the number of write commands journaled in the non-volatile solid state memory system exceeding a predetermined amount.

13. The IHS of claim 8, wherein in response to detecting a power up and determining that the storage system is in the storage system second mode, the storage system first enters the storage system first mode before transitioning to the storage system second mode.

14. The IHS of claim 8, wherein in response to determining that a storage system first mode event has occurred while the storage system is in the storage system second mode, the storage system transitions to the storage system first mode.

15. A method for providing a storage system, comprising:
providing a storage system having at least one controller element coupled to a non-volatile solid state memory system;
operating the storage system in a storage system first mode, wherein the operating in the storage system first mode includes the at least one controller element receiving write commands and journaling the write commands in the non-volatile solid state memory system;
transitioning the storage system form the storage system first mode to a storage system second mode; and
operating the storage system in the storage system second mode, wherein the operating in the storage system second mode includes the at least one controller element executing the write commands journaled in the non-volatile solid state memory system.

16. The method of claim 15, wherein the operating in the storage system first mode further comprises:
receiving read commands by the at least one controller element; and
executing the read commands using the at least one controller element.

17. The method of claim 16, wherein the executing the read commands further comprises:
in response to the at least one controller element determining that a logical address in a read command corresponds to a journaled address for a write command journaled in the non-volatile solid state memory system, reading data from the non-volatile solid state memory system using the at least one controller element

18. The method of claim 15, wherein the storage system first mode consumes less power than the storage system second mode.

19. The method of claim 15, further comprising:
detecting a power up;
determining that the storage system is in the storage system second mode and, in response, entering the storage system first mode before transitioning to the storage system second mode.

20. The method of claim 15, further comprising:
determining that a storage system first mode event has occurred while the storage system is in the storage system second mode and, in response, transitioning to the storage system first mode.
